(19) United States
(12) Patent Application Publication
(10) Pub. No.: US 2012/0092682 A1
(43) Pub. Date: Apr. 19, 2012

(54) Bang Em Up

(76) Inventors: Nader George Saleba Qura, Bristow, VA (US); Lamia Saleba Qura, Bristow, VA (US)

(21) Appl. No.: 12/860,904

(22) Filed: Oct. 19, 2010

(51) Int. Cl. G06F 15/00

(52) U.S. Cl. 358/1.1

(57) ABSTRACT

A design of two fists facing forward, the fists can be with or without gloves and with or without the wrists. The design is two fists ready to bank two other firsts. The intention of the design is using the logo on shirts, hats, towels, mugs, and any marketing materials to be distributed and sold to stores and individuals as well as online.

We, Nader George Qura and Lamia Saleba Qura, have invented a new logo design for Bang Em Up as set forth in the following specification.

This is a logo design, with two fists banging two other fists. The logo is intended to be used on shirts, hats, towels, mugs, and any marketing materials to be distributed and sold to stores and individuals nationwide.

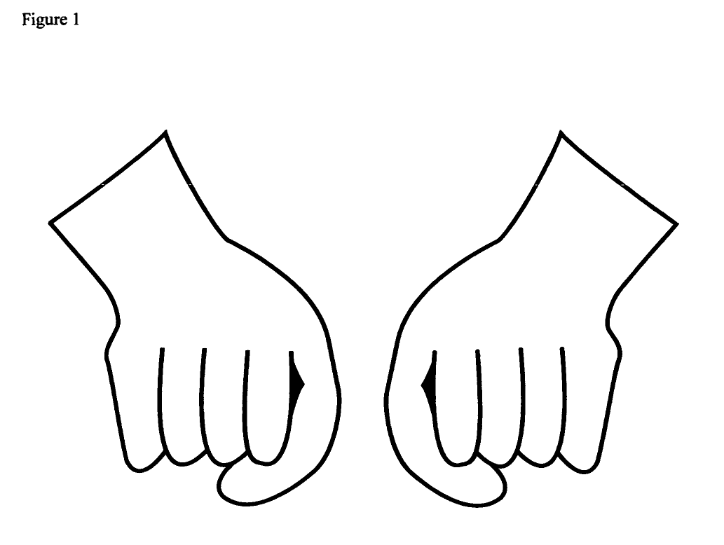

FIG. 1 is a view of the fists banging with the wrists.

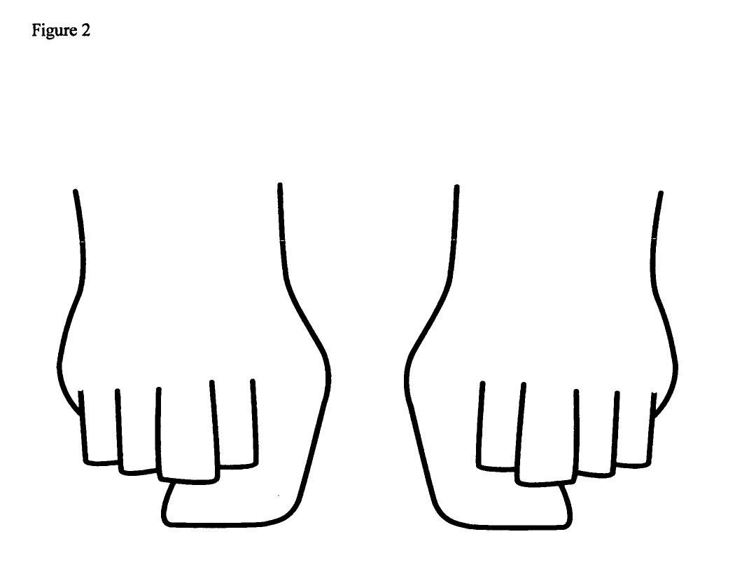

FIG. 2 is a view of the fists banging without the wrists.

1. We, Nader George Qura and Lamia Saleba Qura claim the Ban Em Up logo design. The design is a logo intended to be printed and used on any marketing materials.
The designs are as shown in FIG. 1 and FIG. 2.
The design is to include but not limited to T-shirts, mugs, hats, towels, and any other printing products and materials.
This design is to be distributed and sold to individuals and stores nationwide.
